(19) United States
(12) Patent Application Publication
(10) Pub. No.: US 2025/0178043 A1
(43) Pub. Date: Jun. 5, 2025

(54) METHOD AND INTERNET OF THINGS (IOT) SYSTEM FOR PIPELINE DRYING TREATMENT BASED ON SMART GAS SAFETY SUPERVISION

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Bin LIU, Chengdu (CN); Hongjian LIU, Chengdu (CN); Yuefei WU, Chengdu (CN)

(73) Assignee: CHENGDU QINCHUAN IOT TECHNOLOGY CO., LTD., Chengdu (CN)

(21) Appl. No.: 19/051,194

(22) Filed: Feb. 12, 2025

(30) Foreign Application Priority Data
Dec. 30, 2024 (CN) 202411975357.1

(51) Int. Cl. B08B 9/055; G16Y 40/10; G16Y 40/20; G16Y 40/35

(52) U.S. Cl. CPC B08B 9/0551; G16Y 40/10; G16Y 40/20; G16Y 40/35

(57) ABSTRACT

Disclosed is a method and an Internet of Things (IoT) system for pipeline drying treatment based on smart gas safety supervision. The IoT system comprises a gas company management platform, a government gas supervision management platform, a gas company object platform, etc. The method comprises obtaining drying medium information of at least one gas pipeline outlet; determining an initial drying value of at least one gas pipeline; in response to the initial drying value being less than a drying threshold, using the at least one gas pipeline as a target gas pipeline, and determining a progressive drying parameter; generating a first control instruction to be sent to the gas company object platform; evaluating a confidence level of the initial drying value; generating a threshold adjustment instruction, and sending the threshold adjustment instruction to the gas company management platform to update the drying threshold; and generating a performance adjustment instruction.

### CROSS-REFERENCE TO RELATED APPLICATIONS

This application claims priority to Chinese Application No. 202411975357.1, filed on Dec. 30, 2024, the entire contents of which are incorporated herein by reference.

### TECHNICAL FIELD

The present disclosure relates to the technical field of gas pipeline drying, and in particular to a method and an Internet of Things (IoT) system for pipeline drying treatment based on smart gas safety supervision.

### BACKGROUND

After a gas pipeline is put into service, a buildup of debris occurs inside the gas pipeline. In order to ensure that gas can be used properly, the gas pipeline needs to be cleaned and dried on a regular or irregular basis. An ordinary gas pipeline cleaning device is complicated and inefficient, which is difficult to accomplish cleaning and drying the inside of the gas pipeline quickly and effectively. Therefore, how to simplify the operation and quickly and efficiently clean and dry the inside of the gas pipeline is an urgent problem to solve today.

Aiming at the problem of complicated operation of the gas pipeline cleaning device, CN112692011A provides a gas pipeline cleaning and maintenance device, which optimizes the overall structural design of the gas pipeline cleaning device to make the device quickly clean the inside debris of the pipeline and operate simply. However, the problems that after the pipeline is cleaned, water accumulates in low regions, and gaseous residual water attached to the pipeline wall is difficult to remove, etc. are not solved, which requires evaluation and further treatment of the drying effect inside the pipeline.

Therefore, a method and an IoT system for pipeline drying treatment based on smart gas safety supervision are provided to solve the problem of affecting the quality of natural gas caused by incomplete drying of the inside of the gas pipeline, thereby improving the cleaning quality and effect of the gas pipeline.

### SUMMARY

One or more embodiments of the present disclosure provide a method for pipeline drying treatment based on smart gas safety supervision, implemented by an Internet of Things (IoT) system for pipeline drying treatment based on smart gas safety supervision. The method may comprise: through a gas company management platform: obtaining drying medium information of at least one gas pipeline outlet; determining an initial drying value of at least one gas pipeline based on the drying medium information; in response to determining that the initial drying value of the at least one gas pipeline is less than a drying threshold, using the at least one gas pipeline as a target gas pipeline, and determining a progressive drying parameter based on the initial drying value of the target gas pipeline; generating a first control instruction based on the progressive drying parameter and sending the first control instruction to a gas company object platform, the gas company object platform performing progressive drying on the target gas pipeline based on the first control instruction; obtaining detection data of the target gas pipeline during the progressive drying and sending the detection data to a government gas supervision management platform; through the government gas supervision management platform: evaluating a confidence level of the initial drying value based on the detection data during the progressive drying; generating a threshold adjustment instruction based on the confidence level of the initial drying value, and sending the threshold adjustment instruction to the gas company management platform to cause the gas company management platform to update the drying threshold; and generating a performance adjustment instruction based on the confidence level of the initial drying value.

One of the embodiments of the present disclosure provides an Internet of Things (IoT) system for pipeline drying treatment based on smart gas safety supervision. The IoT system may comprise a government gas supervision management platform, a government gas supervision sensor network platform, a government supervision object platform, a gas company sensor network platform, and a gas company object platform. The government supervision object platform may include a gas company management platform. The gas company management platform may be configured to obtain drying medium information of at least one gas pipeline outlet; determine an initial drying value of at least one gas pipeline based on the drying medium information; in response to determining that the initial drying value of the at least one gas pipeline is less than a drying threshold, use the at least one gas pipeline as a target gas pipeline, and determine a progressive drying parameter based on the initial drying value of the target gas pipeline; generate a first control instruction based on the progressive drying parameter and send the first control instruction to the gas company object platform, the gas company object platform performing progressive drying on the target gas pipeline based on the first control instruction; obtain detection data of the target gas pipeline during the progressive drying and send the detection data to the government gas supervision management platform; the government gas supervision management platform being configured to evaluate a confidence level of the initial drying value based on the detection data during the progressive drying; generate a threshold adjustment instruction based on the confidence level of the initial drying value, and send the threshold adjustment instruction to the gas company management platform to cause the gas company management platform to update the drying threshold; and generate a performance adjustment instruction based on the confidence level of the initial drying value.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic structural diagram illustrating an Internet of Things (IoT) system for pipeline drying treatment based on smart gas safety supervision according to some embodiments of the present disclosure;

FIG. 2 is a flowchart illustrating an exemplary method for pipeline drying treatment based on smart gas safety supervision according to some embodiments of the present disclosure;

FIG. 3 is a schematic diagram illustrating an exemplary process of determining a sub-drying value according to some embodiments of the present disclosure;

FIG. 4 is a flowchart illustrating an exemplary process of adjusting a progressive drying parameter according to some embodiments of the present disclosure; and

FIG. 5 is a schematic diagram illustrating an exemplary natural drying model according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “device,” “unit” and/or “module” used herein are a way to distinguish between different components, elements, parts, sections, or assemblies at different levels. However, the terms may be replaced by other expressions if other words accomplish the same purpose.

As shown in the present disclosure and in the claims, unless the context clearly suggests an exception, the words “one,” “a,” “an,” “one kind,” and/or “the” do not refer specifically to the singular, but may also include the plural. Generally, the terms “including” and “comprising” suggest only the inclusion of clearly identified steps and elements, however, the steps and elements that do not constitute an exclusive list, and the method or apparatus may also include other steps or elements.

Flowcharts are used in the present disclosure to illustrate the operations performed by a system according to embodiments of the present disclosure, and the related descriptions are provided to aid in a better understanding of the magnetic resonance imaging method and/or system. It should be appreciated that the preceding or following operations are not necessarily performed in an exact sequence. Instead, steps can be processed in reverse order or simultaneously. Also, it is possible to add other operations to these processes or to remove a step or steps from these processes.

A gas pipeline needs to be cleaned periodically after being put into service to prevent a large number of impurities from accumulating in the pipeline. CN112692011A focuses on rapid cleaning of debris inside the gas pipeline and simple operation by designing a reasonable device structure, but fails to solve the problem of evaluating the drying effect inside the pipeline and dealing with the undried. Therefore, some embodiments of the present disclosure initially determine a drying situation distribution based on a cleaning parameter, a drying parameter, a pipeline feature, an ambient temperature, etc., and determine an actual drying degree in combination with internal monitoring data. Meanwhile, a first drying instruction is generated based on the drying situation distribution to control a robot to reach a corresponding position, and then a progressive drying parameter is determined combined with the actual drying degree to control the robot to treat an incompletely dried pipeline region based on the progressive drying parameter. In the way, the drying situation inside the gas pipeline can be better determined and the incompletely dried region can be further treated, thereby ensuring the drying efficiency and improving the cleaning quality and effect of the gas pipeline.

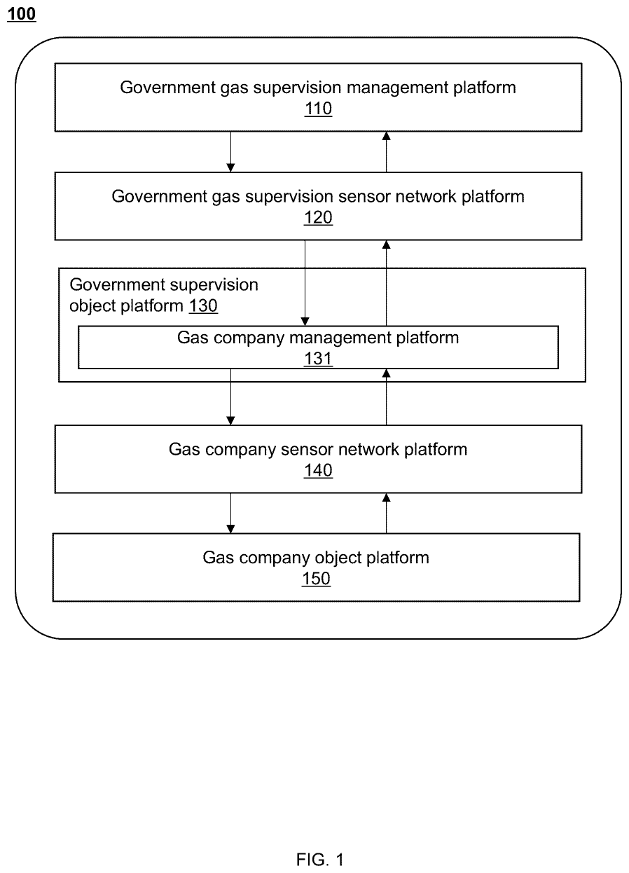

FIG. 1 is a schematic structural diagram illustrating an Internet of Things (IoT) system for pipeline drying treatment based on smart gas safety supervision according to some embodiments of the present disclosure.

In some embodiments, as shown in FIG. 1, an IoT system 100 for pipeline drying treatment based on smart gas safety supervision may include a government gas supervision management platform 110, a government gas supervision sensor network platform 120, a government supervision object platform 130, a gas company sensor network platform 140, and a gas company object platform 150 which are connected in sequence.

The government gas supervision management platform 110 is a platform for processing data related to government gas supervision. In some embodiments, the government gas supervision management platform 132 may be configured as a processor. The data related to government gas supervision may include a confidence level of an initial drying value, a threshold adjustment instruction, a performance adjustment instruction, etc.

The government gas supervision sensor network platform 120 is a platform used by the government for sensing communication. In some embodiments, the government gas supervision sensor network platform 120 may be configured as a gateway device or a communication device, etc., to realize a data interaction function.

In some embodiments, the government gas supervision sensor network platform 120 may be in communication with the government gas supervision management platform 110 and the gas company management platform 131 of the government supervision object platform 130. For example, the government gas supervision sensor network platform 120 may obtain detection data, an initial drying value, etc., sent by the gas company management platform 131 and upload the detection data, the initial drying value, etc., to the government gas supervision management platform 110. As another example, the government gas supervision sensor network platform 120 may obtain the threshold adjustment instruction, the performance adjustment instruction, etc., generated by the government gas supervision management platform 110 and send the threshold adjustment instruction, the performance adjustment instruction, etc., to the gas company management platform 131.

The government supervision object platform 130 is a direct source platform for a government user to access supervision information.

In some embodiments, the government supervision object platform 130 may include the gas company management platform 131.

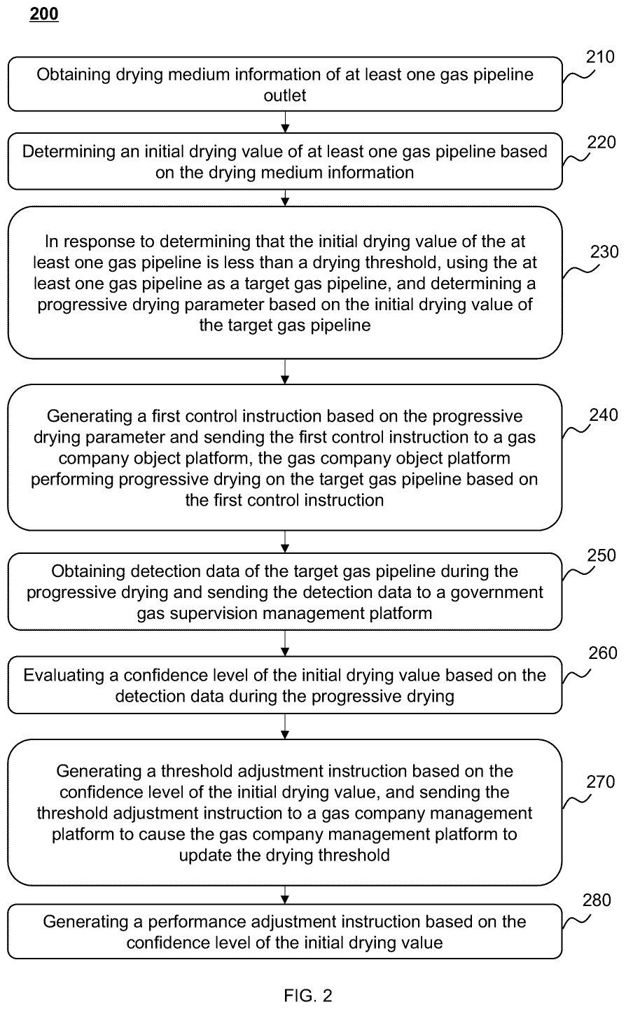

The gas company management platform 131 is a platform for managing and analyzing data related to a gas company. In some embodiments, the gas company management platform 131 may include a data center and a detection database. The data center may be configured to store and manage data related to gas pipeline drying treatment. In some embodiments, the data center may be configured as a storage device. The detection database is a database for detection data of a gas pipeline. In some embodiments, the detection database may be part of the data center or may be a separate storage device. More descriptions regarding the detection data may be found in FIG. 2 and the related descriptions thereof.

In some embodiments, the gas company management platform 131 may be configured to obtain drying medium information of at least one gas pipeline outlet; determine an initial drying value of at least one gas pipeline based on the drying medium information; in response to determining that the initial drying value of the at least one gas pipeline is less than a drying threshold, use the at least one gas pipeline as a target gas pipeline, and determine a progressive drying parameter based on the initial drying value of the target gas pipeline; generate a first control instruction based on the progressive drying parameter and send the first control instruction to the gas company object platform 150, the gas company object platform 150 performing progressive drying on the target gas pipeline based on the first control instruction; obtain detection data of the target gas pipeline during the progressive drying and send the detection data to the government gas supervision management platform 110.

In some embodiments, the drying medium information may further include a drying medium flow rate. The gas company management platform 131 may be further configured to determine water discharge data of the at least one gas pipeline based on the drying medium information; and determine the initial drying value based on the water discharge data.

In some embodiments, the at least one gas pipeline may include at least one pipeline segment. The initial drying value may include a sub-drying value of the at least one pipeline segment. The gas company management platform 131 may be further configured to determine position information of the at least one pipeline segment by segmenting the at least one gas pipeline based on gas pipeline information; and determine the sub-drying value of the at least one pipeline segment based on the position information of the at least one pipeline segment, and the water discharge data.

In some embodiments, the gas company management platform 131 may be further configured to determine a residual water position in the at least one gas pipeline based on the gas pipeline information; and determine the position information of the at least one pipeline segment by segmenting the at least one gas pipeline based on the residual water position. More descriptions regarding the residual water position may be found in FIG. 2 and the related descriptions thereof.

In some embodiments, the gas company management platform 131 may be further configured to construct a water discharge map based on the position information of the at least one pipeline segment and the water discharge data, wherein the water discharge map includes nodes and edges, the nodes include the at least one pipeline segment, node features of the nodes include the position information of the at least one pipeline segment, the gas pipeline information, the drying medium information, and the residual water position, directions of the edges include a flow direction of a drying medium, and edge features of the edges include a diameter of a connection of the at least one pipeline segment; and determine the sub-drying value of the at least one pipeline segment based on the water discharge map through a drying evaluation model, the drying evaluation model being a graph neural network model.

In some embodiments, the gas company management platform 131 may be further configured to determine an actual drying value of the target gas pipeline based on the detection data of the target gas pipeline; determine a correction value based on the actual drying value and the initial drying value; and correct an initial drying value of a candidate gas pipeline based on the correction value.

In some embodiments, the gas company management platform 131 may be further configured to determine a similar gas pipeline of the target gas pipeline based on the gas pipeline information; and correct an initial drying value of the similar gas pipeline based on the correction value.

In some embodiments, the gas company management platform 131 may be further configured to determine a water amount of the target gas pipeline based on the initial drying value and target gas pipeline information; determine the progressive drying parameter based on the water amount; obtain first detection data of a first position before the progressive drying, and evaluate a first drying value of the target gas pipeline at the first position based on the first detection data; generate a parameter adjustment instruction based on the first drying value; and adjust the progressive drying parameter of a second position based on the parameter adjustment instruction.

In some embodiments, the target gas pipeline may include a plurality of pipeline segments. The gas company management platform 131 may be further configured to predict an airflow drying effect of each of the plurality of pipeline segments at the second position based on the first drying value; determine a natural drying duration of the target gas pipeline at the second position based on the airflow drying effect, and a second drying value, the second drying value being a drying value of each of the plurality of pipeline segments at the second position; and remove a drying position of which a natural drying duration is less than a preset duration threshold from the progressive drying parameter.

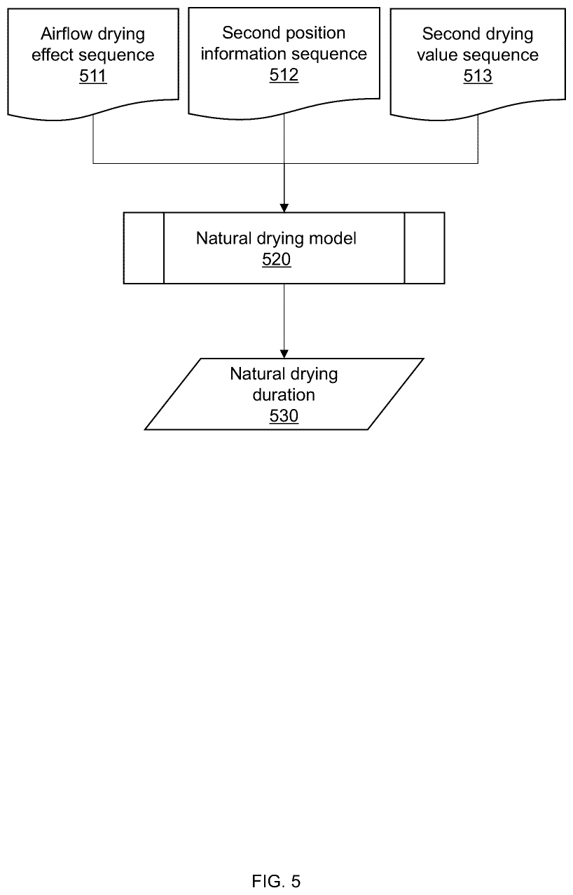

In some embodiments, the gas company management platform 131 may be further configured to determine the natural drying duration through a natural drying model based on an airflow drying effect sequence, a second position information sequence, and a second drying value sequence, the natural drying model being a machine learning model. More descriptions regarding the natural drying model may be found in FIG. 5 and the related descriptions.

The gas company sensor network platform 140 is a functional platform used by the gas company to monitor and transmit data related to drying treatment of the gas pipeline. In some embodiments, the gas company sensor network platform 140 may be configured as the gateway device or the communication device to realize the data interaction function.

In some embodiments, the gas company sensor network platform 140 may be in communication with the gas company management platform 131 of the government supervision object platform 130 and the gas company object platform 150. For example, the gas company sensor network platform 140 may obtain the drying medium information uploaded by the gas company object platform 150 and send the drying medium information to the gas company management platform 131 of the government supervision object platform 130. As another example, the gas company sensor network platform 140 may obtain the first control instruction sent by the gas company management platform 131 of the government supervision object platform 130 and send the first control instruction to the gas company object platform 150.

The gas company object platform 150 is a functional platform for sensing information generation and controlling information execution.

In some embodiments, the gas company object platform may be configured as a drying device, a blowing device, a detection device, a crawler robot, etc.

The drying device is a device that preliminarily dries the gas pipeline. For example, the drying device may include at least one of a pipeline cleaner, an air compressor unit and heating device, a nitrogen displacement device, etc.

The blowing device is a device that performs blowing for progressive drying of the gas pipeline. The blowing device may include a fan and a heating wire. The fan blows hot air through the heating wire to perform the progressive drying on the gas pipeline.

The detection device is a device that tests an operation parameter related to the gas pipeline. The detection device may be configured as a humidity sensor, a temperature sensor, a flow rate sensor, etc.

The crawler robot is an autonomous device that moves in the gas pipeline. In some embodiments, the crawler robot may be provided with the blowing device and the detection device. The crawler robot may move in the gas pipeline to perform progressive drying for different parts of the gas pipeline based on the blowing device, and obtain detection data of the gas pipeline based on the detection device.

More descriptions may be found in FIGS. 2-5 and the related descriptions thereof.

According to some embodiments of the present disclosure, with the IoT system 100 for pipeline drying treatment based on smart gas safety supervision, a closed loop for information operation can be formed between the gas company object platform 150 and the government gas supervision management platform 110, and the coordinated and regular operation under the unified management of the government supervision object platform 130 can be performed, thereby realizing informatization and intelligence gas pipeline drying treatment.

FIG. 2 is a flowchart illustrating an exemplary method for pipeline drying treatment based on smart gas safety supervision according to some embodiments of the present disclosure. A process 200 is an exemplary process of the method for pipeline drying treatment based on smart gas safety supervision, as shown in FIG. 2. The process 200 may include operations 210-280.

In some embodiments, operations 210-250 may be performed by the gas company management platform 131.

In 210, drying medium information of at least one gas pipeline outlet may be obtained.

A gas pipeline is a gas pipeline after preliminary drying. The preliminary drying may be achieved by a preset process using a drying device. The drying device may include at least one of a pipeline cleaner, an air compressor unit and heating device, a nitrogen displacement device, etc. The preset process may include at least one of a desiccant drying process, a dry air drying process, a nitrogen drying process, etc.

The gas pipeline outlet is an outlet of a drying medium in the gas pipeline. The drying medium is a medium that provides a dry environment or creates a dry condition. The different drying processes use different drying media. For example, the desiccant drying process uses a desiccant (e.g. methanol desiccant), the nitrogen drying process uses nitrogen, the dry air drying process uses dry air, etc.

Drying of the gas pipeline is generally inter-station drying of a long-distance pipeline. That is, the drying medium enters from an inlet of one gas station and exits from a gas pipeline of another gas station. In some embodiments, one or more gas pipeline outlets may be provided.

The drying medium information is information related to the drying medium. In some embodiments, the drying medium information may include a drying medium humidity at the gas pipeline outlet at the end of the preliminary drying.

In some embodiments, the gas company management platform 131 may obtain the drying medium information uploaded by the gas company object platform 151 through the gas company sensor network platform 140. The gas company object platform 151 may obtain the drying medium information through at least one sensor arranged at the at least one gas pipeline outlet. For example, the drying medium humidity is obtained by at least one humidity sensor arranged at the at least one gas pipeline outlet.

In 220, an initial drying value of at least one gas pipeline may be determined based on the drying medium information.

The initial drying value is a numerical value used to characterize a drying degree of the at least one gas pipeline after preliminary drying. The larger the initial drying value, the drier the at least one gas pipeline, and the better the preliminary drying effect.

In some embodiments, the gas company management platform 131 may take the drying medium humidity at the end of the preliminary drying as a theoretical humidity of the at least one gas pipeline to calculate to the initial drying value of the at least one gas pipeline. The initial drying value may be negatively correlated with the theoretical humidity.

For example, the gas company management platform 131 may calculate to obtain the initial drying value by Equation (1) shown below:

The initial drying value=1/theoretical humidity (1).

The theoretical humidity is a theoretical humidity value in the at least one gas pipeline after the preliminary drying.

In some embodiments, the gas company management platform 131 may determining water discharge data of the at least one gas pipeline based on the drying medium information; and determine the initial drying value based on the water discharge data.

The water discharge data is data related to water discharge from the at least one gas pipeline outlet during the preliminary drying. In some embodiments, the water discharge data may include a water discharge rate, a water discharge amount, etc. The water discharge rate is a rate at which water is discharged from the at least one gas pipeline outlet during the preliminary drying. The water discharge amount is a water amount of the drying medium discharged from the at least one gas pipeline outlet during the preliminary drying.

In some embodiments, the gas company management platform 131 may obtain the drying medium flow rates and the drying medium humidities of a plurality of consecutive moments during the preliminary drying; calculate a sub-water discharge amount of two consecutive moments based on drying medium flow rates and drying medium humidities of the two consecutive moments; add the plurality of consecutive sub-water discharge amounts to obtain a total water discharge amount; and calculate a sub-water discharge rate based on the sub-water discharge amounts and a duration between the two consecutive moments.

In some embodiments, the gas company management platform 131 may perform curve fitting on the plurality of sub-water discharges and the sub-water discharge rates during the preliminary drying to determine a water discharge data change curve; integrate the water discharge data change curve to obtain a total water amount in the at least one gas pipeline; take a difference between the total water amount in the at least one gas pipeline and the water discharge amount as a residual water amount in the at least one gas pipeline; and determine the initial drying value based on the residual water amount in the at least one gas pipeline and the gas pipeline information. The water discharge data change curve reflects a change in the sub-water discharge amounts and the sub-water discharge rates in a plurality of time periods during the preliminary drying. The plurality of time periods are time periods consisting of a plurality of consecutive moments during the preliminary drying.

The gas company management platform 131 may calculate a volume of the at least one gas pipeline based on a diameter and a length of the at least one gas pipeline in the gas pipeline information, use a ratio of the residual water amount to the volume as the theoretical humidity, and calculate the initial drying value based on Equation (1). More descriptions regarding the Equation (1) may be found above. More descriptions regarding the gas pipeline information may be found below.

The initial drying value may be determined based on the water discharge data, which can calculate to obtain the water discharge data based on a plurality of detection data, and perform fitting to obtain the total water amount before the preliminary drying of the at least one gas pipeline, so as to calculate the residual water amount. The initial drying value may be determined based on the residual water amount, which makes the initial drying value more accurate, and reduce the error caused by directly measuring the drying medium humidity.

In some embodiments, the at least one gas pipeline may include at least one pipeline segment. The initial drying value may include a sub-drying value of the at least one pipeline segment.

The at least one pipeline segment is at least one pipeline segment obtained by segmenting the same gas pipeline. Each of the at least one pipeline segment may be a pipeline segment. Different pipeline segments may correspond to different sub-drying values.

In some embodiments, the gas company management platform 131 may segment the at least one gas pipeline based on the gas pipeline information, and determine position information of the at least one pipeline segment; and determine the sub-drying value of the at least one pipeline segment based on the position information of the at least one pipeline segment and the water discharge data.

The gas pipeline information is information related to a size and/or a distribution of the at least one gas pipeline, etc., such as a length, a diameter, a material, a use duration, a branch, a joint, an elbow of the at least one gas pipeline, etc. In some embodiments, the gas company management platform 131 may obtain the gas pipeline information uploaded by the government gas supervision management platform 110 through the government gas supervision sensor network platform 120. A government user may upload the gas pipeline information to the government gas supervision management platform 110 through a user terminal.

In some embodiments, the gas company management platform 131 may segment the at least one gas pipeline based on the gas pipeline information in various ways. For example, the gas company management platform 131 may segment different branch pipelines into different pipeline segments. As another example, the gas company management platform 131 may use gas pipelines of different materials as different pipeline segments. As another example, the gas company management platform 131 may use gas pipelines of different diameters as different pipeline segments.

In some embodiments, the gas company management platform 131 may determine a residual water position in the at least one gas pipeline based on the gas pipeline information; and determine the position information of the at least one pipeline segment by segmenting the at least one gas pipeline based on the residual water position.

The residual water position is a position in the gas pipeline where water is likely to be retained, such as a depression, a joint, a branch, an elbow, etc.

In some embodiments, the residual water position may be determined based on prior experience. For example, a position where accumulated water is present in historical data is set as the residual water position based on the experience.

In some embodiments, the gas company management platform 131 may use the residual water position as a demarcation point of the at least one pipeline segment, and segment the at least one gas pipeline according to the demarcation point to obtain a plurality of pipeline segments.

The accumulated water accumulated at the residual water position affects the drying value of a nearby pipeline. Segmentation is performed according to the residual water position can obtain a finer and more accurate drying value, which provides accurate data reference for determining a progressive drying parameter below.

The position information of the at least one pipeline segment is information used to indicate a position of the at least one pipeline segment in the at least one gas pipeline. The position information of the at least one pipeline segment may be expressed based on a distance of the at least one pipeline segment from an inlet and/or an outlet of the at least one gas pipeline.

In some embodiments, the gas company management platform 131 may construct a feature vector based on the water discharge data and the position information of the at least one pipeline segment, retrieve in a vector database based on the feature vector, and use a reference drying value corresponding to a reference vector with a highest similarity as the sub-drying values of different pipeline segments.

The vector database may include a plurality of reference vectors and corresponding reference drying values. The vector database may be constructed based on an actual drying value, the corresponding position information of the pipeline segment and the water discharge data. More descriptions regarding the actual drying value may be found in FIG. 2 and the related descriptions below.

In some embodiments, the feature vector may further include the residual water position. More descriptions regarding the residual water position may be found in the related descriptions above.

The gas pipeline between gas plant stations is not a single pipeline, but may have branch and shape differences. During the preliminary drying, the drying situation of each pipeline segment may have a difference, and the amount of residual water left during the drying may be different. Meanwhile, the desiccant absorbs a large amount of water in the early stage of entering the pipeline, leading to saturation of water absorption, and it is difficult to absorb more water at a later stage, resulting in relatively low drying value of pipeline segments close to the pipeline outlet. Accordingly, by determining the sub-drying value of the at least one pipeline segment, the obtained drying value can be more accurate.

In some embodiments, the gas company management platform 131 may be configured to determine an actual drying value of a target gas pipeline based on detection data of the target gas pipeline; determine a correction value based on the actual drying value and the initial drying value; and correct an initial drying value of a candidate gas pipeline based on the correction value.

The target gas pipeline is a gas pipeline that requires progressive drying. More descriptions regarding the target gas pipeline may be found below. More descriptions regarding the initial drying value may be found in the related descriptions above.

The candidate gas pipeline refers to one of all gas pipelines other than the target gas pipeline. The initial drying value of the candidate gas pipeline may be greater than or equal to a drying threshold.

The actual drying value may be configured to characterize an actual drying of the target gas pipeline.

In some embodiments, the gas company management platform 131 may obtain an actual water amount detected by a crawler robot in different pipeline segments, determine the sub-drying values corresponding to the different pipeline segments based on the actual water amount through Equation (1), and use a statistical value of the sub-drying values of the different pipeline segments as the actual drying value. More descriptions regarding Equation (1) may be found above. The statistic value may be an average value.

The correction value is an initial drying value after correction.

In some embodiments, the gas company management platform 131 may determine at least one correction coefficient corresponding to at least one target gas pipeline based on the actual drying value and the initial drying value of the at least one target gas pipeline; use a product of a statistical value of the at least one correction coefficient and the initial drying value of the candidate gas pipeline as the correction value; and adjust the initial drying value of the candidate gas pipeline to the correction value. The statistical value of the at least one correction coefficient may be an average value of the at least one correction coefficient.

The correction coefficient may be positively correlated with the actual drying value of the target gas pipeline and negatively correlated with the initial drying value of the target gas pipeline. For example, the gas company management platform 131 may determine the correction coefficient by Equation (2) shown below:

The correction coefficient=actual drying value/initial drying value (2).

In some embodiments, the gas company management platform 131 may re-determine the candidate gas pipelines based on a corrected initial drying value, and use a candidate gas pipeline of which the corrected initial drying value is lower than the drying threshold as the target gas pipeline to carry out the progressive drying.

The initial drying value may be calculated based on a drying medium humidity at the gas pipeline outlet, which may be an estimated value and may deviate from an actual humidity inside the gas pipeline. The correction coefficient may be determined based on actual detection data of the crawler robot in the target gas pipeline to correct the initial drying value of the candidate gas pipeline, such that the target gas pipeline that satisfies conditions can be further selected to avoid omission of the target gas pipeline.

In some embodiments, the gas company management platform 131 may determine a similar gas pipeline of the target gas pipeline based on the gas pipeline information; and correct an initial drying value of the similar gas pipeline based on the correction value. More descriptions regarding the gas pipeline information may be found above.

The similar gas pipeline is a gas pipeline of at least one candidate gas pipeline that is similar to the target gas pipeline. In some embodiments, the gas company management platform 131 may construct a first feature vector based on the gas pipeline information, calculate a similarity between a first feature vector of the target gas pipeline and a first feature vector of the candidate gas pipeline, and use a candidate gas pipeline of which the similarity is greater than a similarity threshold as the similar gas pipeline of the target gas pipeline. The similarity may be negatively correlated with a vector distance. The vector distance may be a Euclidean distance, a cosine distance, etc. More descriptions regarding the candidate gas pipeline may be found in the related descriptions above.

In some embodiments, the gas company management platform 131 may obtain a correction coefficient of the target gas pipeline corresponding to the similar gas pipeline; use a product of the correction coefficient and an initial drying value of the similar gas pipeline as the correction value; adjust the initial drying value of the similar gas pipeline to the correction value.

Since the gas pipeline is long, comparing whole gas pipelines may have a large difference between different gas pipelines, and thus fewer similar gas pipelines that satisfy the conditions may be selected.

In some embodiments, for one pipeline segment of the target gas pipeline, the gas company management platform 131 may construct a second feature vector based on gas pipeline information, position information, and a residual water position of the pipeline segment; query a reference feature vector of which a similarity is greater than a similarity threshold, calculate a similarity between the second feature vectors of the different pipeline segments of the target gas pipeline and a second feature vector of the at least one pipeline segment of the candidate gas pipeline, and use a pipeline segment of which the similarity greater than the similarity threshold as the similar pipeline segment. The vector database may include a plurality of gas pipeline segments of all the candidate gas pipelines and the corresponding reference feature vectors. The reference feature vectors may be constructed based on the gas pipeline information, the position information, and the residual water position of the gas pipeline segments of candidate gas pipelines.

In some embodiments, the gas company management platform 131 may calculate the correction coefficient of the at least one pipeline segment of the target gas pipeline based on the actual drying value and the sub-drying value of the at least one pipeline segment of the target gas pipeline through Equation (2), use a product of the correction coefficient and the sub-drying value of the similar pipeline segment as the correction value of the similar pipeline segment, and adjust the sub-drying value of the similar pipeline segment to the correction value. More descriptions regarding the actual drying value and the sub-drying value may be found in the related descriptions above.

In some embodiments, if the similar pipeline segment is corresponding to pipeline segments of a plurality of target gas pipelines, a weighted value of the correction values of the pipeline segments of the plurality of target gas pipelines may be calculated, and the weighted value may be used as a final correction value of the similar pipeline segment. A weight may be determined based on a similarity of the reference feature vectors of the pipeline segment, to the second feature vectors of the pipeline segments of the plurality of target gas pipelines. The weight may be positively correlated with the similarity.

Only the similar gas pipeline is corrected, which ensures the accuracy of the correction operation and avoids invalid operation.

In 230, in response to determining that the initial drying value of the at least one gas pipeline is less than a drying threshold, the at least one gas pipeline may be used as a target gas pipeline, and a progressive drying parameter may be determined based on the initial drying value of the target gas pipeline.

The drying threshold is a critical value for the initial drying value of the gas pipeline. The drying threshold may be set based on experience or demand.

More descriptions regarding the target gas pipeline may be found in the related descriptions above.

The progressive drying is further drying of the at least one gas pipeline. Water accumulated in a low-lying region of the gas pipeline, residual water in liquid form attached to a pipeline wall, etc. are difficult to be completely removed by the preliminary drying, and further the progressive drying is required. The progressive drying may be carried out by a crawler robot entering the gas pipeline. A blowing device provided on the crawler robot may blow hot air through the fan and the electric heating wire, so as to dry places with high humidity such as the low-lying region in the gas pipeline. More descriptions regarding the crawler robot and the blowing device may be found in FIG. 1 and the related descriptions thereof.

The progressive drying parameter is a parameter related to the progressive drying of the target gas pipeline, such as a drying position, a blowing air rate and a blowing duration of a fan on the blowing device, a heating power of the heating wire on the blowing device, etc. The drying position is a position at which the crawler robot is located when performing the progressive drying on the target gas pipeline. For one target gas pipeline, the pipeline may be long and have a plurality of low regions, and the crawler robot may stay at a plurality of positions of the target gas pipeline to ensure the progressive drying effect.

In some embodiments, the gas company management platform 131 may be uniformly provided with a plurality of drying positions based on a length of the at least one gas pipeline. A distance between adjacent drying positions may be determined based on the initial drying value. The smaller the initial drying value, the smaller the distance.

In some embodiments, the gas company management platform 131 may set the heating power of the heating wire on the blowing device based on a difference between the initial drying value of the target gas pipeline and the drying threshold. The greater the difference, the greater the heating power.

In some embodiments, the gas company management platform 131 may set the blowing air rate and the blowing duration of the fan on the blowing device based on a distance of the drying position from the gas pipeline outlet. The longer the distance, the higher the blowing air rate, and the longer the blowing duration, such that the water can be blown out of the at least one gas pipeline.

In 240, a first control instruction may be generated based on the progressive drying parameter and sent to the gas company object platform 151, and the gas company object platform 151 may perform progressive drying on the target gas pipeline based on the first control instruction.

The first control instruction is an operation instruction for controlling a drying device of the crawler robot to perform the progressive drying. In some embodiments, the gas company object platform 151 may control the blowing device of the crawler robot to perform the progressive drying on the target gas pipeline based on the first control instruction. More descriptions regarding the crawler robot and the blowing device may be found in FIG. 1 and the related descriptions thereof.

In 250, detection data of the target gas pipeline during the progressive drying may be obtained and sent to the government gas supervision management platform 110.

The detection data is actual water data detected by the crawler robot in the gas pipeline. In some embodiments, the detection data may include an air humidity and a water accumulation in the gas pipeline. The water accumulation may include a water accumulation area and a water accumulation depth.

In some embodiments, the gas company management platform 131 may obtain detection data uploaded by the gas company object platform 151 through the gas company sensor network platform 140. The gas company object platform 151 may obtain the air humidity of the gas pipeline through a humidity sensor disposed on the crawler robot; and obtain the water accumulation in the gas pipeline through an acoustic wave detector.

In some embodiments, operations 260-280 may be performed by the government gas supervision management platform 110.

In 260, a confidence level of the initial drying value may be evaluated based on the detection data during the progressive drying.

The confidence level of the initial drying value is used to characterize a confidence degree of the initial drying value.

In some embodiments, the government gas supervision management platform 110 may determine a theoretical water amount in the gas pipeline based on the theoretical humidity and the size of the at least one gas pipeline; determine an actual water amount based on the detection data; and determine the confidence level of the initial drying value based on a difference between the theoretical water amount and the actual water amount.

The size of the at least one gas pipeline may include a volume inside the gas pipeline. The size of the at least one gas pipeline may be calculated based on the length and the diameter of the at least one gas pipeline in the gas pipeline information.

The theoretical water amount is a water amount theoretically remaining in the gas pipeline after the preliminary drying. In some embodiments, the government gas supervision management platform 110 may use a product of the theoretical humidity and the size of the at least one gas pipeline as the theoretical water amount.

The actual water amount is a water amount that is actually detected in the gas pipeline after the preliminary drying. The actual water amount may include a water amount and an accumulated water amount in the air. In some embodiments, the actual water amount may be positively correlated with the air humidity, the size of the at least one gas pipeline, the water accumulation area, and the water accumulation depth. The government gas supervision management platform 110 may calculate the actual water amount by Equation (3).

The actual water amount=air humidity×size of at least one gas pipeline+water density×water accumulation area×a water accumulation depth (3).

The confidence level of the initial drying value may be positively correlated with an absolute value of a difference between the theoretical water amount and the actual water amount. For example, the government gas supervision management platform 110 may calculate the confidence level of the initial drying value by Equation (4).

The confidence level of the initial drying value=1−|A−B|/B (4).

Where A denotes the initial drying value and B denotes the actual drying value.

In 270, a threshold adjustment instruction may be generated based on the confidence level of the initial drying value, and sent to the gas company management platform to cause the gas company management platform to update the drying threshold.

The threshold adjustment instruction is an operation instruction for adjusting the drying threshold.

In some embodiments, the government gas supervision management platform 110 may generate the threshold adjustment instruction in response to determining that the confidence level of the initial drying value is less than a preset threshold.

In some embodiments, an adjusted drying threshold may be positively correlated with the confidence level of the initial drying value. The lower the confidence level of the drying value, the lower the adjusted drying threshold.

In some embodiments, the gas company management platform 131 may determine the candidate gas pipeline based on the operations 210-240 to further select an additional target gas pipeline of which an initial drying value is lower than the adjusted drying threshold, and perform the progressive drying on the additional target gas pipeline. Accordingly, the incompletely dried gas pipeline may be selected as the target gas pipeline for the progressive drying as far as possible to avoid omission. More descriptions regarding the candidate gas pipeline may be found in the related descriptions above.

In 280, a performance adjustment instruction may be generated based on the confidence level of the initial drying value.

The performance adjustment instruction is an instruction for adjusting a frequency at which a processor of the government gas supervision management platform 110 acquires and processes data related to different gas company. The data related to different gas companies is data related to drying treatment of the at least one gas pipeline of the gas companies, such as the drying medium information, the gas pipeline information, the detection data, and the threshold adjustment instruction of the at least one gas pipeline of the gas companies, etc.

In some embodiments, the government gas supervision management platform 110 may generate the performance adjustment instruction based on reciprocals of confidence levels of the initial drying values of the different gas companies, and adjust a performance allocation strategy. The performance allocation strategy refers to a frequency at which the processor of the government gas supervision management platform 110 processes the data related to different gas companies.

The government gas supervision management platform 110 may use a ratio of an average value of the reciprocals of the confidence levels of the initial drying values of a plurality of gas pipelines of the different gas companies as a ratio of the frequency at which the processor processes the data related to the different gas companies to generate the performance adjustment instruction, and adjust the performance allocation strategy.

By analyzing the initial drying value, a gas pipeline with incomplete preliminary drying may be evaluated, and different progressive drying parameters may be provided based on different initial drying values to carry out further progressive drying for the incompletely dried gas pipeline, so as to improve the overall drying effect of the at least one. The drying threshold may be adjusted based on the confidence level of the initial drying value, and the incompletely dried gas pipeline may be further selected as the target gas pipeline for the progressive drying. The lower the confidence level of the gas company, the more likely that the final drying is incomplete, which leads to a quality problem and/or a safety problem of gas usage. Accordingly, the processor needs to process the detection data acquired by the crawler robot at a higher frequency to improve the accuracy of data processing and timeliness of determination.

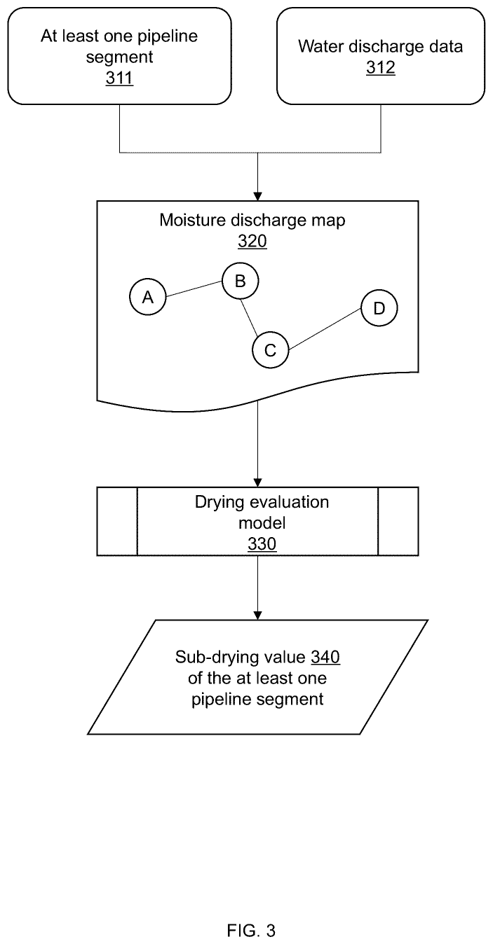

FIG. 3 is a schematic diagram illustrating an exemplary process of determining a sub-drying value according to some embodiments of the present disclosure.

In some embodiments, as shown in FIG. 3, the gas company management platform 131 may be further configured to construct a water discharge map 320 based on at least one pipeline segment 311 and water discharge data 312; determine a sub-drying value 340 of the at least one pipeline segment based on the water discharge map 320 through a drying evaluation model 330.

The water discharge map is used to represent a discharge situation of water in different pipeline segments of the same gas pipeline. One gas pipeline may correspond to one water discharge map. In some embodiments, the water discharge map may include nodes, node features of the nodes, edges, edge features of the edges, etc.

The nodes of the water discharge map may include the at least one pipeline segment. A count of the at least one pipeline segment may be a count of the nodes. For example, as shown in FIG. 3, the nodes include a node A, a node B, a node C, and a node D, which denote four pipeline segments of the gas pipeline.

The node features of the nodes reflect feature information of the at least one pipeline segment. In some embodiments, the node features of the nodes may include position information of the at least one pipeline segment, gas pipeline information, the drying medium information, and a residual water position. More descriptions regarding the position information of the at least one pipeline segment, the gas pipeline information, the drying medium information, and the residual water position may be found in FIG. 2 and the related descriptions thereof.

The edges of the water discharge map are used to indicate a connection relationship between two adjacent pipeline segments. Directions of the edges may include a flow direction of a drying medium

The edge features are used to characterize connection features between the adjacent pipeline segments. The edge features of the edges may include a diameter of a connection of the at least one pipeline segment.

In some embodiments, the gas company management platform 131 may construct the water discharge map based on the at least one pipeline segment and the water discharge data. For example, the gas company management platform 131 may determine at least one node and at least one edge based on the position information of the at least one pipeline segment and the gas pipeline information; use the position information of the at least one pipeline segment, the gas pipeline information, the drying medium information, and the residual water position as the node features of the nodes in the water discharge map; and use a water discharge direction in the water discharge data as one of the directions of the edges. The diameter of the connection between the at least one pipeline segment may be determined by searching a preset table based on the position information in the node features and used as one of the edge features. The preset table may include diameters of the gas pipelines at different positions. The preset table may be constructed based on the gas pipeline information. More descriptions regarding the gas pipeline information may be found in FIG. 1 and the related descriptions thereof.

The drying evaluation model 330 is a model for determining the sub-drying value 340 of the at least one pipeline segment. In some embodiments, as shown in FIG. 3, an input of the drying evaluation model 330 may include the water discharge map 320, and an output of the drying evaluation model 330 may include the sub-drying value 340 of the at least one pipeline segment based on the nodes of the water discharge map. In some embodiments, the drying evaluation model 330 may be a graph neural network (GNN) model.

In some embodiments, the drying evaluation model may be trained based on a large number of first training samples and first labels corresponding to the first training samples.

In some embodiments, the first training samples may include historical water discharge maps of sample gas pipelines constructed based on historical data of a plurality of gas companies. The first labels may be actual drying values corresponding to pipeline segments in the first training samples. The actual drying value refers to an actual drying degree of each sample pipeline. More descriptions regarding the actual drying value and the determination process may be found in FIG. 2 and the related descriptions thereof.

In some embodiments, the drying evaluation model may be trained by the following operations.

1, a training dataset may be obtained. The training dataset may include the plurality of first training samples and the first labels corresponding to the first training samples. The training dataset is a collection of training data from a plurality of gas companies.

2, a plurality of iterations may be performed. At least one of the plurality of iterations may include: selecting one or more training samples from the training dataset, inputting the one or more training samples into the drying evaluation model to obtain model prediction outputs corresponding to the one or more training samples; calculating a value of a loss function by substituting n the model prediction outputs corresponding to the one or more training samples and the labels corresponding to the one or more training samples into a predefined equation of the loss function; and inversely updating model parameters of the drying evaluation model based on the value of the loss function through gradient descent, etc.

In 3, when a iteration end condition is satisfied, the iteration is ended, and the trained drying evaluation model is obtained. Wherein, the iteration end condition may be that the loss function converges, a number of iterations reaches a threshold, or the like.

The water discharge map reflects the characteristics and connectivity of each pipeline segment, and determining the sub-drying value of the pipeline segment through the drying evaluation model based on the water discharge map can help to improve the accuracy and efficiency of predicting the sub-drying value.

In some embodiments, for one of the gas companies, in response to determining that the confidence level of the initial drying value is less than a confidence threshold, the gas company management platform 131 may obtain detection data from the gas company management platform; determine a supplemental training dataset of the drying evaluation model based on the detection data; and train the drying evaluation model based on the supplemental training dataset to obtain the drying evaluation model of the gas company.

In some embodiments, in response to determining that the confidence level of the initial drying value of the gas company is less than confidence threshold, the gas company management platform 131 may obtain the detection data from a detection database of the gas company management platform. More descriptions regarding the confidence level of the initial drying value and the confidence threshold may be found in FIG. 2 and the related descriptions thereof.

The supplemental training dataset is an extended training dataset for a single gas company that is supplemented based on an initial model training dataset. The supplemental training dataset may include a plurality of second training samples and second labels corresponding to the second training samples. For one of the gas companies, the corresponding second training samples may include a plurality of historical water discharge maps constructed based on a plurality of pipeline segments and water discharge data from the historical data of the gas company, and the second labels may include actual drying values of the pipeline segments corresponding to the second training samples.

The drying evaluation model of the gas company is a specific drying evaluation model for a certain gas company. When the gas company management platform 131 obtains data of the gas company, the sub-drying value of the at least one pipeline segment may be determined based on the water discharge map through the drying evaluation model of the gas company.

In some embodiments, the gas company management platform 131 may train obtain the drying evaluation model of the gas company based on the plurality of second training samples and the plurality of second labels of the supplemental training dataset. More descriptions regarding the specific training process may be found in the related descriptions above.

The amount of data of a single gas company may be insufficient, and a general drying evaluation model may be obtained by initial training of the plurality of gas companies. When the confidence level of the initial drying value of a certain gas company is not sufficient, the supplemental training dataset of the gas company may be obtained to perform training based on the existing drying evaluation model so as to obtain a model that can be better applied to the situation of that gas company. Therefore, the sub-drying value determined through the drying evaluation model is more accurate.

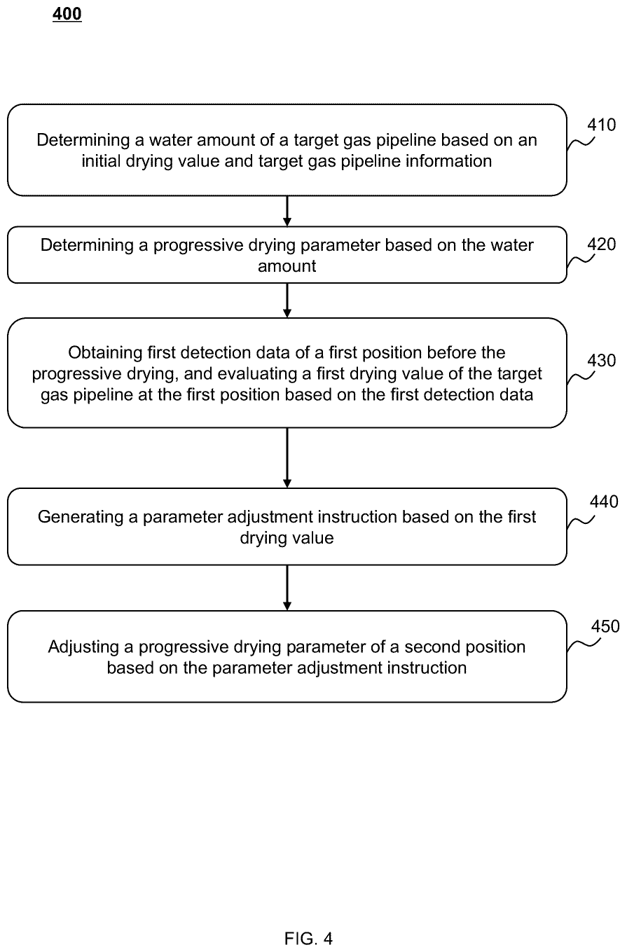

FIG. 4 is a flowchart illustrating an exemplary process of adjusting a progressive drying parameter according to some embodiments of the present disclosure. As shown in FIG. 4, a process 400 may include operations 410-450. The operations 410-450 may be performed through the gas company management platform 131.

In 410, a water amount of a target gas pipeline may be determined based on an initial drying value and target gas pipeline information. More descriptions regarding the initial drying value may be found in FIG. 2 and the related descriptions thereof.

The target gas pipeline information is information related to a target gas pipeline. For example, the target gas pipeline information may include a length, a diameter, a material, a use duration, a branch, a joint and an elbow of the target gas pipeline, etc.

The water amount of the target gas pipeline is a water amount of at least one pipeline segment of the target gas pipeline, and is used for determining a required blowing air rate of a fan and a heating power of a heating wire, etc.

In some embodiments, the gas company management platform 131 may calculate a pipeline volume of the target gas pipeline based on the diameter and the length in the target gas pipeline information; and calculate the water amount of the target gas pipeline based on the pipeline volume and a theoretical humidity corresponding to the initial drying value.

In some embodiments, the gas company management platform 131 may calculate the water amounts of the pipeline segments for different pipeline segments of the target gas pipeline, respectively.

In 420, a progressive drying parameter may be determined based on the water amount. More descriptions regarding the progressive drying parameter may be found in FIG. 1 and the related descriptions thereof.

In some embodiments, the gas company management platform 131 may determine the progressive drying parameter by: setting starting points of different pipeline segment as starting positions of the progressive drying; setting the heating power of the heating wire of the blowing device based on the water amount, the higher the water amount, the higher the heating power; and setting the blowing air rate and a blowing duration of the fan of the blowing device according to the water amount and positions of the pipeline segments. The higher the water amount and the farther the positions of the pipeline segments are from pipeline outlets, the higher the blowing air rate and the longer the blowing duration. The starting points of the pipeline segments refer to starting positions of a flow direction of a drying medium.

In 430, first detection data of a first position before the progressive drying is obtained, and a first drying value of the target gas pipeline at the first position is evaluated based on the first detection data.

The first position is a real-time position at which a crawler robot is located at a certain pipeline segment of the target gas pipeline and does not perform drying treatment on the pipeline segment. The first position may be represented by position information of the pipeline segment in which the crawler robot is located. More descriptions regarding the position information of the pipeline segment may be found in FIG. 2 and the related descriptions thereof. The progressive drying of a pipeline segment before the first position in a crawling route of the crawler robot may be completed.

The first detection data is actual water data acquired by the crawler robot at the first position in the gas pipeline. For example, the first detection data may include an air humidity, a water accumulation, etc. in the pipeline segment at the first position.

In some embodiments, the first detection data may be obtained by a humidity sensor or an acoustic wave detector provided on the crawler robot.

The first drying value is a sub-drying value of the pipeline segment at the first position. The first drying value may change with the progressive drying of an upstream pipeline segment. For example, if a temperature of an airflow blowing over the upstream pipeline segment during drying is relatively high, water of the first position may be carried away so as to cause the first drying value to increase. The upstream pipeline segment may be an upstream (i.e., a starting position) of a flow sequence of the drying medium.

In some embodiments, the gas company management platform 131 may take the air humidity in the first detection data as the theoretical humidity, and calculate to obtain the first drying value by Equation (1). More descriptions regarding Equation (1) may be found in FIG. 2 and the related descriptions thereof.

In 440, a parameter adjustment instruction may be generated based on the first drying value.

The parameter adjustment instruction is an instruction for adjusting a progressive drying parameter. For example, the parameter adjustment instruction may include decreasing and/or increasing the blowing air rate and the heating power.

In some embodiments, the gas company management platform 131 may determine the first drying values at different positions based on the first detection data, and compare the first drying values with the initial drying value to determine the parameter adjustment instruction. For example, when the first drying value is higher than the initial drying value, the blowing air rate and the heating power may be reduced; when the first drying value is lower than the initial drying value, the blowing air rate and the heating power may be increased.

In 450, a progressive drying parameter of a second position may be adjusted based on the parameter adjustment instruction.

The second position is a portion of the gas pipeline after the position of the crawler robot in an operation direction of the target gas pipeline. The second position may be located after the first position. That is, the pipeline segment located at the second position does not perform the progressive drying.

In some embodiments, the gas company management platform 131 may send the parameter adjustment instruction to the gas company object platform 151, and the gas company object platform 151 may adjust the progressive drying parameter at the second position based on the parameter adjustment instruction.

The first drying value of the first position may be determined based on the first detection data, and the drying effect of the progressive drying parameter may be evaluated, such that the progressive drying parameter of the second position is adjusted. The influence of the progressive drying of the upstream pipeline on the downstream pipeline is considered, and the progressive drying parameter of the downstream pipeline under progressive drying is adjusted in time according to the influencing effect, thereby realizing a better drying effect of the subsequent pipeline.

In some embodiments, the gas company management platform 131 may determine a natural drying duration of the target gas pipeline at the second position based on an airflow drying effect and a second drying value; remove a drying position of which a natural drying duration is less than a preset duration threshold from the progressive drying parameter.

The airflow drying effect is a drying effect of an airflow generated by the progressive drying on a downstream pipeline segment. For example, a water amount of the downstream gas pipeline may be carried away by the airflow generated by the progressive drying. The downstream pipeline segment may be a downstream (i.e., an outlet) of the flow sequence of the drying medium.

In some embodiments, the gas company management platform 131 may determine a cumulative impact value of one or more pipeline segments on the downstream pipeline segment during the progressive drying based on a difference between the first drying value of the plurality of upstream pipeline segments and the initial drying value, and use the cumulative impact value as the airflow drying effect. The cumulative impact is a result of impact of the initial drying value of each pipeline segment being affected by all the progressive drying operations of the upstream gas pipelines. For example, there are pipeline segments 1, 2, 3, 4, and 5 from upstream to downstream, and the cumulative impact of the pipeline segment 2 is an impact of the initial drying value being affected by the progressive drying of the pipeline segment 1; the cumulative impact of the pipeline segment 4 is an impact of the initial drying value being affected by the progressive drying of the pipeline segments 1, 2, and 3.

The cumulative impact value is a difference between a real-time drying value after the cumulative impact and a drying threshold. More descriptions regarding the drying threshold may be found in FIG. 2 and the related descriptions thereof.

The second drying value is a sub-drying value of a pipeline segment at the second position. The sub-drying value is the initial drying value of the pipeline segment. More descriptions may be found in FIG. 2 and the related descriptions thereof.

The natural drying duration is used to reflect a length of time it takes for the drying value of the downstream pipeline segment to reach the drying threshold only due to the airflow generated by the progressive drying of the upstream pipeline segment. The natural drying duration may be a length of time from the time the crawler robot enters the target gas pipeline to the time the drying value of the downstream pipeline segment reaches the drying threshold due to the effect of the progressive drying of the upstream gas pipeline.

In some embodiments, the natural drying duration may be determined in various ways. For example, the gas company management platform 131 may determine the natural drying duration of the second position based on the airflow drying effect and the second drying value by looking up a preset table. The preset table may include a mapping relationship between the airflow drying effect, the second drying value, and the natural drying duration. The preset table may be constructed based on historical data.

In some embodiments, the gas company management platform 131 may determine the natural drying duration through a natural drying model based on the airflow drying effect, position information of a plurality of pipeline segments of the second position, and the second drying value. More descriptions may be found in FIG. 5 and the related descriptions thereof.

The preset duration threshold is a critical value for the natural drying duration. In some embodiments, the preset duration threshold may be a duration from the time the crawler robot enters the target gas pipeline to the time the crawler robot reaches the pipeline segment. In some embodiments, the gas company management platform 131 may remove a drying position of which the natural drying duration is less than the preset duration threshold from the progressive drying parameter. In other words, the crawler robot does not dry the pipeline segment of the drying position of which the natural drying duration is less than the preset duration threshold.

By the natural drying duration being less than the preset duration threshold, it means that the natural drying of the pipeline segment is completed before the crawler robot reaches the pipeline segment. By removing the drying position of which the natural drying duration is less than the preset duration threshold from the progressive drying parameter, the crawler robot does not need to stay in the pipeline segment that completes the natural drying, which can improve efficiency and safety, and save resources and costs.

FIG. 5 is a schematic diagram illustrating an exemplary natural drying model according to some embodiments of the present disclosure.

In some embodiments, as shown in FIG. 5, the government gas supervision management platform 110 may be configured to determine a natural drying duration 530 through a natural drying model 520 based on an airflow drying effect sequence 511, a second position information sequence 512, and a second drying value sequence 513.

The airflow drying effect sequence 511 is a sequence consisting of airflow drying effects corresponding to the plurality of pipeline segments of the second position. The position information sequence 512 is a sequence consisting of position information of the plurality of pipeline segments of the second position. More descriptions regarding the position information of the pipeline segment may be found in FIG. 2 and the related descriptions thereof. The second drying value sequence 513 is a sequence consisting of sub-drying values of the plurality of pipeline segments of the second position.

The natural drying model 520 is a model for predicting a natural drying duration of a target gas pipeline at the second position. In some embodiments, the natural drying model may be a machine learning model, such as a deep neural networks (DNN) model, etc. More descriptions regarding the airflow drying effect, the second position, the second drying value, and the natural drying duration may be found in FIG. 4 and the related descriptions thereof. More descriptions regarding the position information of the pipeline segment may be found in FIG. 2 and the related descriptions thereof.

In some embodiments, the natural drying model may be obtained by training a large number of third training samples and third labels corresponding to the third training samples. In some embodiments, the plurality of third training samples with the third labels may be input into an initial natural drying model, a loss function may be constructed from the third labels and results of the initial natural drying model, and parameters of the initial natural drying model may be iteratively updated through gradient descent or other processes based on the loss function. The model training may be completed when a preset condition is satisfied, and a trained natural drying model may be obtained. The preset condition may be that the loss function converges, or a count of iterations reaches a threshold, or the like.

Each set of the third training samples may include a sample airflow drying effect sequence, a sample second position information sequence, and a sample second drying value sequence. The third training samples may be obtained from historical data, and use a historical airflow drying effect sequence, a historical second position information sequence and a historical second drying value sequence at the second position when the crawler robot is located in different pipeline segments of the target gas pipeline in the historical data as the third training samples. The third labels corresponding to the third training samples may include a sample natural drying duration corresponding to each set of the third training samples. In some embodiments, the third labels may include actual natural drying durations corresponding to the pipeline segments at the second position corresponding to the third training samples of which a real-time drying value is just greater than the drying threshold as measured subsequently.

The actual natural drying duration reacts to an actual duration taken by the pipeline segment to complete natural drying due to the impact of the progressive drying of the upstream pipeline segment. The actual natural drying duration may be a duration from a first moment to a second moment. The first moment is a moment when the crawler robot enters the target gas pipeline. The second moment is a moment when a real-time drying value detected by the crawler robot at the pipeline segment is just greater than the drying threshold. The second moment may be a moment when the crawler robot performs the progressive drying on the pipeline segment.

The natural drying duration may be predicted through the natural drying model, such that the prediction accuracy of the natural drying duration and the data processing rate of the downstream gas pipeline can be improved.

In some embodiments, a training dataset for the natural drying model may include training samples from a plurality of acquisition environments. Distribution parameters of the training samples from the plurality of acquisition environments may be determined based on historical data.

The acquisition environments may include an ambient temperature and an ambient humidity when the training samples are acquired. The acquisition environments may be obtained based on a temperature sensor and a humidity sensor arranged in the environments.

The distribution parameters of the training samples reflect a distribution of the training samples during acquisition. In some embodiments, the distribution parameters of the training samples may include an acquisition environment coverage when the training samples are acquired, and a count proportion of the training samples acquired under different acquisition environment stages.

The acquisition environment stages may be set according to requirements or experience. For example, one acquisition environment stage may be represented as [(T1, T2), (W1, W2)], where (T1, T2) denotes a temperature range and (W1, W2) denotes a humidity range. For example, if one stage is set for every 5° C. of temperature and one stage is set for every 5% of humidity, the acquisition environment stage may include: [(10° C., 15° C.), (50%, 55%)], [(10° C., 15° C.), (55%, 60%)], [(10° C., 15° C.), (65%, 70%)] . . . [(15° C., 20° C.), (50%, 55%)], [(15° C., 20° C.), (55%, 60%)], [(15° C., 20° C.), (65%, 70%)] . . . [(20° C., 25° C.), (50%, 55%)], [(20° C., 25° C.), (55%, 60%)], [(20° C., 25° C.), (65%, 70%)] . . .

In some embodiments, the gas company management platform 131 may use a range covered by historical acquisition environment data during drying in historical drying records as the acquisition environment coverage.

In some embodiments, the acquisition environment stage may be set based on a distribution density of historical acquisition environment data in the historical drying records. A larger range of acquisition environment stage may be set for an environment data interval with a low distribution density. For example, a temperature stage is usually set every 5° C., but with fewer occurrences of 0-20° C. in the historical acquisition environments, the range of the environment data interval may be set directly to every 10° C. of a temperature stage.

In some embodiments, a data proportion of training samples acquired in different collection environment stages may be set in an equal proportion.

The diversity of the training data can be ensured by acquiring training samples from various acquisition environments so as to improve the universality of the model in different environments.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about,” “approximately,” or “substantially” in some examples. Unless otherwise stated, “about,” “approximately,” or “substantially” indicates that the number is allowed to vary by +20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A method for pipeline drying treatment based on smart gas safety supervision, implemented by an Internet of Things (IoT) system for pipeline drying treatment based on smart gas safety supervision, comprising:
through a gas company management platform:
obtaining drying medium information of at least one gas pipeline outlet;
determining an initial drying value of at least one gas pipeline based on the drying medium information;
in response to determining that the initial drying value of the at least one gas pipeline is less than a drying threshold, using the at least one gas pipeline as a target gas pipeline, and determining a progressive drying parameter based on the initial drying value of the target gas pipeline;
generating a first control instruction based on the progressive drying parameter and sending the first control instruction to a gas company object platform, wherein the gas company object platform performs progressive drying on the target gas pipeline based on the first control instruction;
obtaining detection data of the target gas pipeline during the progressive drying and sending the detection data to a government gas supervision management platform;
through the government gas supervision management platform:
evaluating a confidence level of the initial drying value based on the detection data during the progressive drying;
generating a threshold adjustment instruction based on the confidence level of the initial drying value, and sending the threshold adjustment instruction to the gas company management platform to cause the gas company management platform to update the drying threshold; and
generating a performance adjustment instruction based on the confidence level of the initial drying value.

2. The method of claim 1, wherein the drying medium information further includes a drying medium flow rate, and the determining an initial drying value of at least one gas pipeline based on the drying medium information includes:
determining water discharge data of the at least one gas pipeline based on the drying medium information; and
determining the initial drying value based on the water discharge data.

3. The method of claim 2, wherein the at least one gas pipeline includes at least one pipeline segment, the initial drying value includes a sub-drying value of the at least one pipeline segment, the method further comprises:
determining position information of the at least one pipeline segment by segmenting the at least one gas pipeline based on gas pipeline information; and
determining the sub-drying value of the at least one pipeline segment based on the position information of the at least one pipeline segment, and the water discharge data.

4. The method of claim 3, wherein the determining position information of the at least one pipeline segment by segmenting the at least one gas pipeline based on gas pipeline information includes:
determining a residual water position in the at least one gas pipeline based on the gas pipeline information; and
determining the position information of the at least one pipeline segment by segmenting the at least one gas pipeline based on the residual water position.

5. The method of claim 3, wherein the determining the sub-drying value of the at least one pipeline segment based on the position information of the at least one pipeline segment, and the water discharge data includes:
constructing a water discharge map based on the at least one pipeline segment and the water discharge data, wherein the water discharge map includes nodes and edges, the nodes include the at least one pipeline segment, node features of the nodes include the position information of the at least one pipeline segment, the gas pipeline information, the drying medium information, and the residual water position, directions of the edges include a flow direction of a drying medium, and edge features of the edges include a diameter of a connection of the at least one pipeline segment; and
determining the sub-drying value of the at least one pipeline segment based on the water discharge map through a drying evaluation model, the drying evaluation model being a graph neural network model.

6. The method of claim 2, further comprising:
determining an actual drying value of the target gas pipeline based on the detection data of the target gas pipeline;
determining a correction value based on the actual drying value and the initial drying value; and
correcting an initial drying value of a candidate gas pipeline based on the correction value.

7. The method of claim 6, wherein the correcting an initial drying value of a candidate gas pipeline based on the correction value includes:
determining a similar gas pipeline of the target gas pipeline based on the gas pipeline information; and
correcting an initial drying value of the similar gas pipeline based on the correction value.

8. The method of claim 1, wherein the determining a progressive drying parameter based on the initial drying value of the target gas pipeline includes:
determining a water amount of the target gas pipeline based on the initial drying value and target gas pipeline information;
determining the progressive drying parameter based on the water amount;
obtaining first detection data of a first position before the progressive drying, and evaluating a first drying value of the target gas pipeline at the first position based on the first detection data;
generating a parameter adjustment instruction based on the first drying value; and
adjusting the progressive drying parameter of a second position based on the parameter adjustment instruction.

9. The method of claim 8, wherein the target gas pipeline includes a plurality of pipeline segments, the first detection data includes detection data of the plurality of pipeline segments obtained in sequence, the method further comprises:
predicting an airflow drying effect of each of the plurality of pipeline segments at the second position based on the first drying value;
determining a natural drying duration of the target gas pipeline at the second position based on the airflow drying effect, and a second drying value, the second drying value being a drying value of each of the plurality of pipeline segments at the second position; and
removing a drying position of which a natural drying duration is less than a preset duration threshold from the progressive drying parameter.

10. The method of claim 9, wherein the determining a natural drying duration of the target gas pipeline at the second position based on the airflow drying effect, and a second drying value includes:
determining the natural drying duration through a natural drying model based on an airflow drying effect sequence, a second position information sequence, and a second drying value sequence, the natural drying model being a machine learning model.

11. An Internet of Things (IoT) system for pipeline drying treatment based on smart gas safety supervision, comprising a government gas supervision management platform, a government gas supervision sensor network platform, a government supervision object platform, a gas company sensor network platform, and a gas company object platform, the government supervision object platform including a gas company management platform; wherein
the gas company management platform is configured to:
obtain drying medium information of at least one gas pipeline outlet;
determine an initial drying value of at least one gas pipeline based on the drying medium information;
in response to determining that the initial drying value of the at least one gas pipeline is less than a drying threshold, use the at least one gas pipeline as a target gas pipeline, and determine a progressive drying parameter based on the initial drying value of the target gas pipeline;
generate a first control instruction based on the progressive drying parameter and send the first control instruction to the gas company object platform, wherein the gas company object platform performs progressive drying on the target gas pipeline based on the first control instruction;
obtain detection data of the target gas pipeline during the progressive drying and send the detection data to the government gas supervision management platform;
the government gas supervision management platform is configured to:
evaluate a confidence level of the initial drying value based on the detection data during the progressive drying;
generate a threshold adjustment instruction based on the confidence level of the initial drying value, and send the threshold adjustment instruction to the gas company management platform to cause the gas company management platform to update the drying threshold; and
generate a performance adjustment instruction based on the confidence level of the initial drying value.

12. The IoT system of claim 11, wherein the drying medium information further includes a drying medium flow rate, and the gas company management platform is further configured to:
determine water discharge data of the at least one gas pipeline based on the drying medium information; and
determine the initial drying value based on the water discharge data.

13. The IoT system of claim 12, wherein the at least one gas pipeline includes at least one pipeline segment, the initial drying value includes a sub-drying value of the at least one pipeline segment, the gas company management platform is further configured to:
determine position information of the at least one pipeline segment by segmenting the at least one gas pipeline based on gas pipeline information; and
determine the sub-drying value of the at least one pipeline segment based on the position information of the at least one pipeline segment, and the water discharge data.

14. The IoT system of claim 13, wherein the gas company management platform is further configured to:
determine a residual water position in the at least one gas pipeline based on the gas pipeline information; and
determine the position information of the at least one pipeline segment by segmenting the at least one gas pipeline based on the residual water position.

15. The IoT system of claim 13, wherein the gas company management platform is further configured to:
construct a water discharge map based on the at least one pipeline segment and the water discharge data, wherein the water discharge map includes nodes and edges, the nodes include the at least one pipeline segment, node features of the nodes include the position information of the at least one pipeline segment, the gas pipeline information, the drying medium information, and the residual water position, directions of the edges include a flow direction of a drying medium, and edge features of the edges include a diameter of a connection of the at least one pipeline segment; and
determine the sub-drying value of the at least one pipeline segment based on the water discharge map through a drying evaluation model, the drying evaluation model being a graph neural network model.

16. The IoT system of claim 12, the gas company management platform is further configured to:
determine an actual drying value of the target gas pipeline based on the detection data of the target gas pipeline;
determine a correction value based on the actual drying value and the initial drying value; and
correct an initial drying value of a candidate gas pipeline based on the correction value.

17. The IoT system of claim 16, wherein the gas company management platform is further configured to:
determine a similar gas pipeline of the target gas pipeline based on the gas pipeline information; and
correct an initial drying value of the similar gas pipeline based on the correction value.

18. The IoT system of claim 11, wherein the gas company management platform is further configured to:
determine a water amount of the target gas pipeline based on the initial drying value and target gas pipeline information;
determine the progressive drying parameter based on the water amount;
obtain first detection data of a first position before the progressive drying, and evaluate a first drying value of the target gas pipeline at the first position based on the first detection data;
generate a parameter adjustment instruction based on the first drying value; and
adjust the progressive drying parameter of a second position based on the parameter adjustment instruction.

19. The IoT system of claim 18, wherein the target gas pipeline includes a plurality of pipeline segments, the gas company management platform is further configured to:
predict an airflow drying effect of each of the plurality of pipeline segments at the second position based on the first drying value;
determine a natural drying duration of the target gas pipeline at the second position based on the airflow drying effect, and a second drying value, the second drying value being a drying value of each of the plurality of pipeline segments at the second position; and
removing a drying position of which a natural drying duration is less than a preset duration threshold from the progressive drying parameter.

20. The IoT system of claim 19, wherein the gas company management platform is further configured to:
determine the natural drying duration through a natural drying model based on an airflow drying effect sequence, a second position information sequence, and a second drying value sequence, the natural drying model being a machine learning model.
